(19) United States
(12) Patent Application Publication
(10) Pub. No.: US 2002/0075352 A1
(43) Pub. Date: Jun. 20, 2002

(54) Method for the formation of colours with a colour printer

(75) Inventors: Petrus Leonardus Johannes Welten, Boxmeer (NL); Fulgencio Arjona-Gomez, Eindhoven (NL); Sigrid Dorothea Haenisch-Habedank, Duisburg (DE); Robert Evert Anthony Braun, Uden (NL)

Correspondence Address: Salvatore J. Abbruzzese, Esq., HOFFMANN & BARON, LLP, 6900 Jericho Turnpike, Syosset, NY, 11791, US

(73) Assignee: Stork Digital Imaging B.V.

(21) Appl. No.: 09/992,297

(22) Filed: Nov. 14, 2001

Related U.S. Application Data
(63) Continuation of application No. PCT/NL00/00338, filed on May 18, 2000.

(30) Foreign Application Priority Data
May 18, 1999 (NL) 1012085

(51) Int. Cl. B41J 2/21

(52) U.S. Cl. 347/43

(57) ABSTRACT

A method for printing color images with the aid of a print head is provided. The operation is carried out in a reciprocating movement relative to a substrate and includes ink nozzles or nozzle arrays that are disposed one behind the other in the direction of movement. The ink nozzles can produce ink of different ink colors, including black. The ink colors from which the pixel color is formed include the color black and the two neighbouring colors of the pixel color in a color space. The color black is applied as the centermost color. Colour differences between pixels formed in the different directions of movement are virtually eliminated in this way.

CROSS-REFERENCE TO RELATED APPLICATION

This is a continuation application of PCT/NL00/0338 filed 18 May, which PCT application claims priority on NL application number 1012085 filed May 18, 1999 herein incorporated by reference.

### FIELD OF THE INVENTION

The invention relates to the formation of colours with a colour printer, such as a colour ink jet printer. More particularly, the invention relates to a method for printing colour images by means of a printing device with a print head, which print head during operation carries out a reciprocating movement relative to a substrate and comprises ink nozzles or nozzle arrays that are disposed one behind the other in a direction of movement of the print head and can produce ink droplets of different ink colours, including black, which method comprises the formation on the substrate of an image with a predetermined pixel colour from ink droplets of different ink colours. Such a method is known in practice.

### BACKGROUND OF THE INVENTION

Of necessity, only a limited number of different ink colours are available in colour printers. However, in order to permit the printing of pixels of any desired pixel colour, ink droplets of different colours are combined in one pixel. Virtually all pixel colours can be obtained by a suitable selection of the ink colours used and of the numbers of ink droplets of the chosen ink colours per pixel. In general, the ink colours worked with are cyan, magenta, yellow and black. Apart from these so-called basic colours, additional colours can also be used.

In the case of colour printers in which the print head carries out a reciprocating movement relative to a substrate and the ink nozzles with different ink colours are disposed one after the other, viewed in a direction of movement, the problem arises that the sequence in which ink droplets of different colours reach the same pixel is dependent upon the direction of movement of the print head. Suppose, for example, that a pixel colour is composed of the basic colours yellow and magenta, yellow being to the right of magenta in the print head. If the print head is moving from left to right, a yellow ink droplet will be applied to the pixel first, and then a magenta ink droplet, so that the magenta ink droplet lies on top of the yellow ink droplet. In the opposite direction of movement magenta will be applied first, and then yellow, so that the yellow ink droplet will lie on top of the magenta ink droplet.

It has been found that reversing the sequence of the composite ink droplets causes colour differences. In particular if several image lines (rows of pixels) are formed, this colour difference can show up as “stripes” in the image. It will be clear that this is undesirable.

Of course, it is possible to solve this problem by not placing the ink nozzles with different ink colours in the print head one behind the other, viewed in the direction of movement, but by placing them below one another. However, this has the disadvantage that register problems occur as a result of shrinkage of the substrate during the application of the ink droplets. These register problems can be compensated for only by using advanced and expensive means.

With a view to preventing colour differences, JP-A-

8/295034 further discloses an embodiment of a print head with seven ink nozzles, in which the ink nozzle with the colour black occupies the central position, and the remaining ink nozzles for the ink colours yellow, magenta and cyan are arranged symmetrically on either side thereof, so that the print head, at least as regards the colour sequence, has a symmetrical layout, proposed as Y₁M₁C₁KC₂M₂Y₂. When this print head is used, the first four adjoining ink nozzles Y₁M₁C₁K are used in a forward movement, and in the return movement the series KC₂M₂Y₂, so that the droplet sequence is the same in the forward and return movement, and black ink droplets are deposited on the substrate first. On account of the presence of so-called “double” colours (2 ink nozzles per colour, apart from black), this print head does not have a compact configuration. Even when one additional colour is used, two ink nozzles must be provided for it.

### SUMMARY OF THE INVENTION

The object of the invention is to eliminate the above and other disadvantages of the prior art and to provide a method for the formation of colours with a colour printer that minimizes the colour difference between the different directions of movement, in particular such a method in which a print head with a compact configuration of the ink nozzles, even more particularly upon using one or more additional colours in addition to the standard colours of black, yellow, magenta and cyan, is used. A further object here is to provide a method for the formation of colours with a colour printer which does not in principle change the layout of the colour printer, so that, for example, the ink nozzles can remain disposed one after the other in the direction of movement.

A method of the type mentioned in the preamble according to the invention is characterized in that the pixel colour is formed from the ink colour black and the two neighbouring ink colours of the pixel colour in a colour space, the colour black being applied as the centremost colour.

By composing such a pixel colour from neighbouring ink colours, i.e., ink colours situated in a colour space in the immediate vicinity of the pixel colour, and the colour black, which is applied as a second or centremost colour, the colour difference of a pixel with the same pixel colour in the forward and return movement of the print head is minimized.

A simple embodiment of the print head used in the case of the method according to the invention to this end comprises an odd number of ink nozzles, in which the ink colour black is allocated to the centremost ink nozzle and the neighbouring ink colours in the colour space are allocated to ink nozzles on either side of the centremost ink nozzle. In the case of such a print head each ink nozzle has a different (its own) colour.

### BRIEF DESCRIPTION OF THE DRAWINGS

The invention will be explained in greater detail below with reference to the following drawings.

FIG. 1 shows diagrammatically a substrate to which pixels are applied.

FIG. 2 shows diagrammatically a first example of a colour space with a number of ink colours.

FIG. 3 shows diagrammatically a second example of a colour space with a number of ink colours.

FIG. 4 shows diagrammatically a first example of a print head according to the invention.

FIG. 5 shows diagrammatically a second example of a print head according to the invention.

### DESCRIPTION OF THE PREFERRED EMBODIMENTS

A first special case occurs with the use of a print head with an even number of ink nozzles. In such a case the colour black can be allotted to the two centremost ink nozzles—after all, black is used most—while the remaining neighbouring ink colours in the colour space are distributed in the manner described above over the remaining ink nozzles. In that case the number of ink colours is equal to the number of ink nozzles minus 1, because the ink colour black is “doubly” present.

A further special case occurs with the use of a print head with an even number of ink nozzles and an equal number of ink colours. In that case it is not possible to place the ink nozzle with the colour black precisely in the centre of the row. When such a print head is used, the method according to the invention is characterized in that the number of ink nozzles is even and equal to the number of ink colours, and in that the pixel colour is formed from the ink colour black and the two neighbouring ink colours of the pixel colour in a colour space with the greatest mutual colour distance, the ink colour with the greatest colour distance relative to black being applied as the centremost colour. For a simple print head with ink nozzles for the primary colours cyan (C), magenta (M) and yellow (Y) and the colour black (K), a print head with ink nozzles in the sequence CKYM is then obtained.

The use of the methods according to the invention ensures that the occurrence of stripes in the printed image is virtually entirely eliminated, while the print head used has a compact configuration.

The invention further provides a print head and an ink jet printer for application of the above methods. In the case of a print head according to the invention with a row of an odd number of ink nozzles situated one after the other in a direction of movement of the print head, and each with a different ink colour, the ink colour black is situated in the centre of the row, and neighbouring ink colours in the colour space are situated on either side of the ink colour black. A print head according to the invention with a row of an even number of ink nozzles situated one after the other in a direction of movement is characterized in that the ink nozzle with the ink colour black is situated adjoining the centre of the row, and in that ink nozzles with neighbouring ink colours in the colour space are situated on either side of the ink nozzle with the ink colour black, provided that the ink colour with the greatest colour distance relative to both black and a neighbouring colour is situated on the same side of black as that neighbouring colour and adjoining the centre of the row.

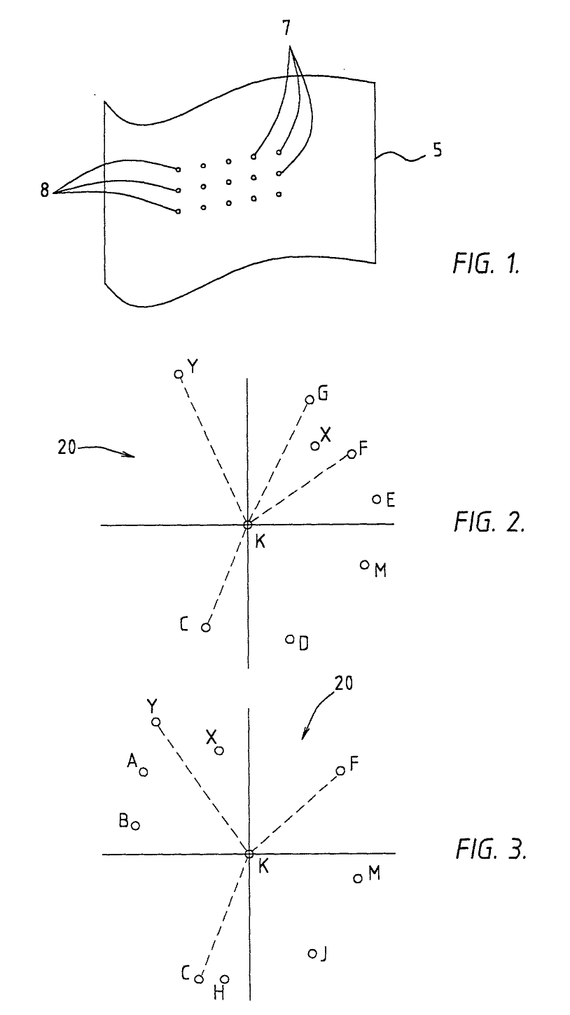

The substrate 5 shown only partially and by way of example in FIG. 1 can be made of textile or paper. Pixels 7 are applied to the substrate 5 by means of a printing device (not shown). The pixels 7 form image lines 8. A print head (not shown) of the printing device carries out a forward and backward first movement relative to the substrate 5 in successive strokes during operation. During each stroke, ink droplets are applied to the substrate, thereby forming the pixels 7 of an image line 8 (droplet deposition) in each case. After each stroke, the print head carries out a second movement relative to the substrate 5, which movement is, for example, caused by conveyance of the substrate. The second movement is in principle perpendicular to the first movement, so that the following image line will be applied parallel to the previous image line.

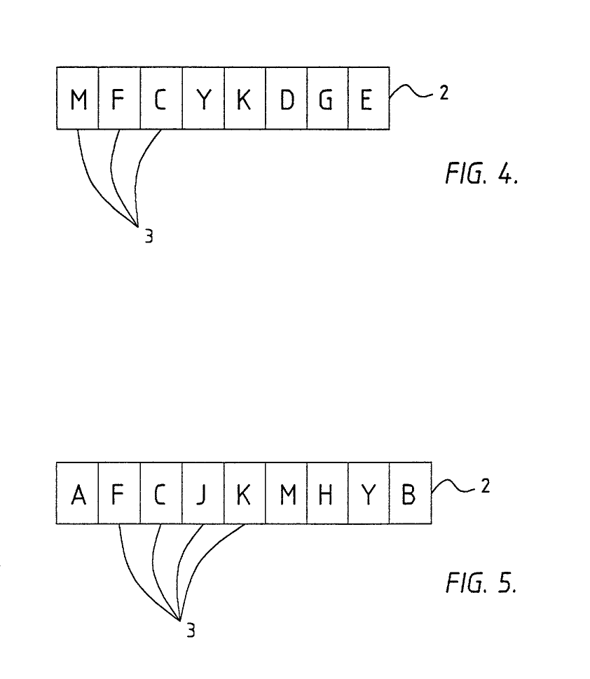

The print head contains a number of ink nozzles, each with its own ink colour (see FIG. 4). The ink nozzles are disposed in a row, the direction of which corresponds to the direction of the first movement. During a stroke, several ink nozzles generally apply one or more ink droplets to the same pixel. Since the ink nozzles are disposed one after the other, viewed in the direction of movement, the sequence in which ink droplets of different ink nozzles, and thus of different colours, are applied in a particular pixel will depend on the direction of movement of the print head. If a pixel colour is, for example, composed of the ink colours black (K), magenta (M) and cyan (C), this can produce the sequence KMC in the first stroke and the sequence CMK in a second stroke. This difference in sequence gives rise to colour differences. The invention aims to offer a solution to this.

In the colour space 20 shown diagrammatically in FIG. 2 the colours yellow (Y), magenta (M), cyan (C) and black (K) are illustrated. The colour black (K) in this case is projected on the centre of the colour space shown as a plane here. In the embodiment shown, four additional colours are selected, blue (D), red (E), orange (F) and golden yellow (G). In this example the first additional colour (D) lies between the basic colours cyan (C) and magenta (M). Furthermore the second, third and fourth additional colours (E, F and G) lie between the basic colours magenta (M) and yellow (Y). The total number of ink colours is eight.

Suppose that a pixel colour X has to be depicted. This colour X can in principle be composed in various ways, for example from the basic colours yellow (Y), magenta (M) and black (K). The combination yellow (Y) and red (E) combined with black (K) can also be selected. However, according to the invention in this example the neighbouring colours golden yellow (G) and orange (F) combined with black (K) are used. As can be seen from FIG. 2, the colours golden yellow (G) and orange (F) are the colours lying closest to the pixel colour (X). In other words, the line connecting the colour golden yellow (G) to the centre of the colour space lies closer to the pixel colour (X) than the line connecting the colour yellow (Y) to the centre of the colour space. In the same way, the line connecting the colour orange (F) to the centre of the colour space lies closer to the pixel colour (X) than the corresponding line of other colours. By now using the colours golden yellow (G) and orange (F) combined with black-black (K) being deposited between golden yellow (G) and orange (F)—for composing the pixel colour (X), the colour difference between the forward and return direction becomes minimal, with the result that the effect of the direction of the print head, and consequently of the sequence of the ink droplets, is virtually eliminated.

The basic colours yellow (Y), magenta (M), cyan (C) and black (K) are present in the colour space 20 shown in FIG. 3, as in FIG. 2. In this example the first additional colour (F) lies between yellow and magenta, the second additional colour (J) and the third additional colour (H) lie between magenta and cyan, and the fourth and fifth additional colours (B and A) lie between the colours cyan and yellow. The total number of ink colours is nine here.

Here again, the colour difference between pixels formed in the forward and return direction of the print head can be minimized by selecting as ink colours the neighbouring colours of a pixel colour (X) and the colour black (K), black (K) being deposited between the neighbouring colours.

The print head 2 according to the invention, shown only by way of example in FIG. 4, comprises a row of ink nozzles 3, each with its own ink colour. In a print head according to the prior art the arrangement of the ink nozzles within a row would be arbitrary. However, a print head 2 according to the invention has a specific arrangement.

First, in a print head according to the invention the colour black (K) lies in or at least near the centre. In the case of an odd number of ink nozzles (FIG. 5) the ink nozzle with the colour black will be exactly the centremost ink nozzle. In the case of an even number of ink nozzles (FIG. 4) the ink nozzle with the colour black will immediately adjoin the centre and, for example, in a row of eight ink nozzles will take up the fourth or fifth position.

Secondly, in a print head according to the invention the remaining colours are distributed in such a way that in a colour space neighbouring colours are disposed as far as possible on either side of the colour black. If now each pixel colour is formed from two neighbouring colours and black, this arrangement will ensure that black is always applied as the second or centremost colour. Consequently, the black ink on the substrate will always lie between the other two colours. This, and the selection of neighbouring colours, will mean that colour differences between pixels formed in different strokes of the print head are virtually entirely eliminated.

Thirdly, in a print head according to the invention the arrangement of the colours can be composed in a specific way. First, in a colour space 20 (see FIG. 2) in which black (K) lies at least approximately in the centre, the two most neighbouring colours are selected, i.e., the colours in the colour space with the shortest distance between them. This colour distance can be determined, for example, with the aid of the coordinates of the colours according to the CIELAB standard. The two most neighbouring colours are, for example, the colours M and E, which together with the colour K (black) form a first segment of the colour space. The starting row of the print head then becomes MKE; the neighbouring colours M and E on either side of K, K in this case obviously lying in the centre. A colour that is the “most neighbouring” relative to E and M, i.e. is the shortest distance from E or M in the colour space, is then sought. Supposing this is F, F and E being neighbouring, then the new row becomes MFKE or FMKE, with F and E on either side of K. In this case K adjoins the centre.

In a similar way the colours G, Y and D are added in succession, with the respective rows MFKGE, MFYKGE and MFYKDGE. Finally, the colour C is added.

The problem arising here is that C has both D and Y as neighbouring colours and therefore, strictly speaking, cannot be placed either to the left or to the right of K. This is a direct consequence of the even number of ink nozzles and ink colours. According to a further aspect of the invention, C is now placed at the side of K where the most differing colour is situated, i.e., the colour with the greatest colour distance both relative to the neighbouring colours of that colour and relative to black (K). Supposing Y is the most differing colour, then C is placed to the left of K, since Y is also situated to the left of K, and Y is placed in the “centre”, i.e., next to K: MFCYKDGE. This means that the two centre positions are taken up by Y and K. If the combination of colours Y, C and K has to be printed, Y will lie in the centre, instead of K.

In the case of FIG. 5 an odd number of ink nozzles, each with one ink colour, is present. In this case the distribution of the odd number of ink colours (e.g. as shown in FIG. 3) is not a problem, and K will take up the centremost position of the row of ink nozzles and always lie in the centre during the printing.

Persons skilled in the art will realize that the invention is not restricted to the exemplary embodiments shown and that various modifications and additions can be made within the scope of the invention.

What is claimed is

1. Method for printing colour images by means of a printing device with a print head, which print head during operation carries out a reciprocating movement relative to a substrate and comprises ink nozzles that are disposed one behind the other in a direction of movement of the print head and can produce ink droplets of different ink colours, including black, which method comprises the formation on the substrate of a pixel with a predetermined pixel colour from ink droplets of different ink colours, which pixel colour is formed from the ink colour black and the two neighbouring ink colours of the pixel colour in a colour space, wherein the colour black is applied as the centremost colour.

2. Method according to claim 1, wherein the ink colours, in addition to black, also comprise yellow, cyan, magenta and at least one additional colour.

3. Method for printing colour images by means of a printing device with a print head, which print head during operation carries out a reciprocating movement relative to a substrate and comprises ink nozzles that are disposed one behind the other in a direction of movement of the print head and can produce ink droplets of different ink colours, including black, which method comprises the formation on the substrate of a pixel with a predetermined pixel colour from ink droplets of different ink colours, wherein the number of ink nozzles is even and equal to the number of ink colours, and wherein the pixel colour is formed from the ink colour black and the two neighbouring ink colours of the pixel colour in a colour space with the greatest mutual colour distance, the ink colour with the greatest colour distance relative to black being applied as the centremost colour.

4. Method according to claim 3, wherein the ink colours, in addition to black, also comprise yellow, cyan, magenta and at least one additional colour.

5. Print head for use with the method according to claim 1, which print head comprises a row of an odd number of ink nozzles situated one after the other in a direction of movement of the print head, and each with a different ink colour, in which the ink nozzle with the ink colour black is situated in the centre of the row, and ink nozzles with neighbouring ink colours in the colour space are situated on different sides of the ink colour black.

6. Print head according to claim 5, wherein the colours black, yellow, cyan, magenta and at least one additional colour are allocated to the ink nozzles.

7. Print head according to claim 6, wherein the ink colours magenta, cyan, a third additional colour, yellow, black, a first additional colour, a fourth additional colour and a second additional colour are allocated in succession to the ink nozzles.

8. Print head for use with the method according to claim 1, which print head comprises a row of an even number of ink nozzles situated one after the other in a direction of movement of the print head, the number of ink colours being equal to said even number of ink nozzles minus 1, in which two ink nozzles with the ink colour black are situated in the centre of the row, and ink nozzles with neighbouring ink colours in the colour space are situated on different sides of the ink colour black.

9. Print head according to claim 8, wherein the colours black, yellow, cyan, magenta and at least one additional colour are allocated to the ink nozzles.

10. Print head according to claim 9, wherein the ink colours magenta, cyan, a third additional colour, yellow, black, a first additional colour, a fourth additional colour and a second additional colour are allocated in succession to the ink nozzles.

11. Print head for use with the method according to claim 3, which print head comprises a row of an even number of ink nozzles situated one after the other in a direction of movement of the print head, each with a different ink colour, in which the ink nozzle with the ink colour black is situated adjoining the centre of the row, and in which ink nozzles with neighbouring ink colours in the colour space are situated on different sides of the ink nozzle with the ink colour black, provided that the ink colour with the greatest colour distance relative to both black and a neighbouring colour is situated on the same side of black as said neighbouring colour and adjoining the centre of the row.

12. Print head according to claim 11, wherein the colours black, yellow, cyan, magenta and at least one additional colour are allocated to the ink nozzles.

13. Print head according to claim 12, wherein the ink colours magenta, cyan, a third additional colour, yellow, black, a first additional colour, a fourth additional colour and a second additional colour are allocated in succession to the ink nozzles.

14. Ink jet printer comprising means for carrying out the method according to claim 1.

15. Ink jet printer comprising means for carrying out the method according to claim 3.
